(19) United States
(12) Patent Application Publication
(10) Pub. No.: US 2009/0079954 A1
(43) Pub. Date: Mar. 26, 2009

(54) Method and Device for Measuring Distances

(76) Inventors: Alton Smith, Clayton, GA (US); Gregory Carras, Woodstock, GA (US); David Jones, Decatur, GA (US); Chris Johnson, Mount Pleasant, SC (US)

Correspondence Address: Fay Kaplun & Marcin, LLP/ Motorola, 150 Broadway Suite 702, New York, NY, 10038, US

(21) Appl. No.: 11/860,211

(22) Filed: Sep. 24, 2007

(51) Int. Cl. G01C 3/02

(52) U.S. Cl. 356/3.03; 356/3

(57) ABSTRACT

Described are systems/devices and methods for measuring distances using a laser distance meter. The device may include a range finder measuring a distance; and a processor receiving the distance from the range finder and performing a calculation based on the distance. The method may include steps of determining, using a range finder included in a mobile device, a distance; and calculating, using a processor of the mobile device, one of an area and a volume based on the distance.

### FIELD OF INVENTION

The present application generally relates to systems/devices and methods for measuring distances using a laser distance meter. Specifically, the exemplary system and methods allow a hand-operated device equipped with one or more laser distance meters to calculate distances, areas of a two dimensional space, and volumes of a three-dimensional space.

### BACKGROUND

Laser range-finders are devices that use a laser beam to determine the distance to a reflecting object. The most common form of laser range-finder operates on the time of flight principle by sending a laser pulse in a narrow beam towards the object and measuring the time taken by the pulse to be reflected off the target and returned to the sender.

Depending on the demands of the laser range finder and/or application of the device, very different approaches can be appropriate. Specifically, due to the high speed of light, certain techniques may not be appropriate for high precision sub-millimeter measurements, thus triangulation and other techniques are often used. Triangulation is basically a geometric method, useful for distances in the range of about 1 millimeter to many kilometers. Time-of-flight measurements, or “pulse measurements,” are based on measuring the time of flight of a laser pulse from the measurement device to some target and back again. Such methods are typically used for large distances like hundreds of meters or many kilometers. The use of advanced techniques, such as time-of-flight methods, allows for measuring of very large distances with an accuracy of a few centimeters. Typical accuracies of simple devices for short distances are a few millimeters or centimeters.

Mobile devices (e.g., personal/enterprise digital assistants (“PDAs”/“EDAs”), wireless telephones, barcode scanners, image-based scanners, radio frequency identification (“RFID”) readers, radio transceivers, video recorders, etc.) are used in a multitude of situations for both personal and business purposes. These devices often utilize various components such as wireless transceivers for communication over a network.

### SUMMARY OF THE INVENTION

The present invention relates to systems/devices and methods for measuring distances using a laser distance meter. The device may include a range finder measuring a distance; and a processor receiving the distance from the range finder and performing a calculation based on the distance. The method may include steps of determining, using a range finder included in a mobile device, a distance; and calculating, using a processor of the mobile device, one of an area and a volume based on the distance.

### BRIEF DESCRIPTION OF THE DRAWINGS

FIG. 1A shows an exemplary system for determining area and/or volume measurements of an operating environment within a handheld mobile unit (“MU”), wherein the operating environment may include plurality of boundaries according to the exemplary embodiments of the present invention.

FIG. 1B shows an alternative exemplary embodiment of the MU for determining area and/or volume measurements of the operating environment according to the exemplary embodiments of the present invention.

FIG. 2A shows an exemplary system for determining an overall area measurement of an operating environment with the MU according to the exemplary embodiments of the present invention.

FIG. 2B shows the exemplary system for determining an overall area measurement of operating environment with the MU wherein the operating environment includes an obstacle according to the exemplary embodiments of the present invention.

FIG. 3A shows an exemplary system for determining an overall volume measurement of an operating environment with the MU according to the exemplary embodiments of the present invention.

FIG. 3B shows the exemplary system for determining an overall volume measurement of operating environment with the MU wherein the operating environment includes an obstacle according to the exemplary embodiments of the present invention.

FIG. 4 shows an exemplary method for measuring distances using a laser distance meter of a hand-operated device, such as MU, according to the exemplary embodiments of the present invention.

### DETAILED DESCRIPTION

The exemplary embodiments of the present invention may be further understood with reference to the following description of exemplary embodiments and the related appended drawings, wherein like elements are provided with the same reference numerals. The exemplary embodiments of the present invention are related to systems and methods used for measuring distances and performing calculations based on the measured distances using a handheld device. Specifically, the present invention is related to systems and methods for utilizing one or more laser distance meters on a mobile unit (“MU”) in order to calculate an area measurement and/or a volume measurement within a specific. The exemplary systems and method described herein may allow provide the MU with software applications for calculating areas and volumes that complement the use of laser distance meters.

Laser distance meter are highly accurate and may often be found in both commercial and residential contracting fields. Furthermore, laser distance meters according to the exemplary embodiments of the present invention may be implemented in the retail sector, wherein shelf-space and plannogram measurements may require quick and accurate readings. In addition, the travel and transportation industry may implement the various embodiments of the present invention for fast and accurate determinations of cargo space and trailer/container capacity measurements. Thus, various embodiments of the present invention will be described with reference to a laser distance meter. However, those skilled in the art will understand that the present invention may be any electrical and/or mechanical distance meter(s), e.g., range-finding mechanism(s), that is couplable to a hand-operated device, such as the MU.

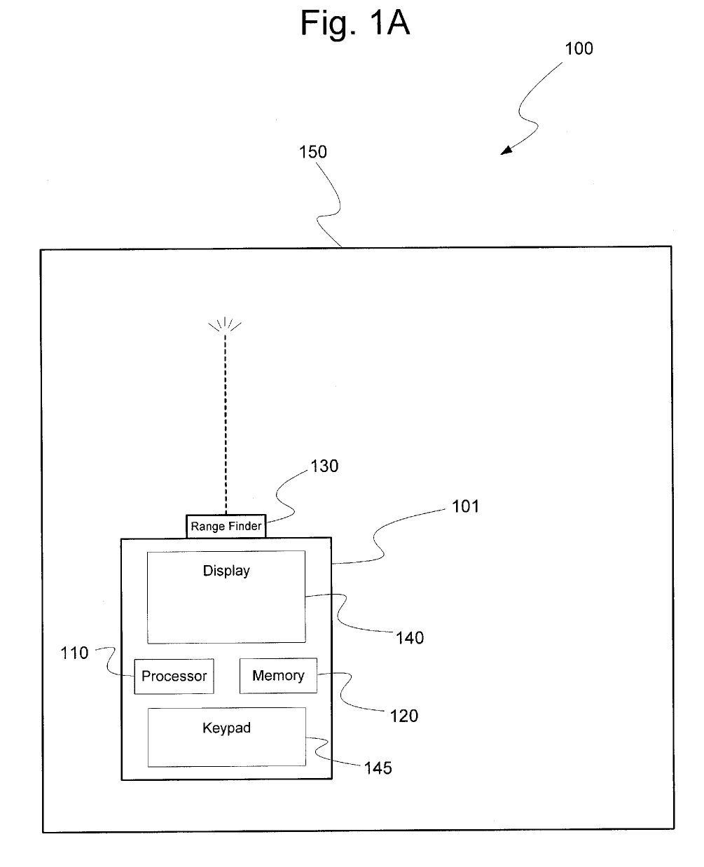

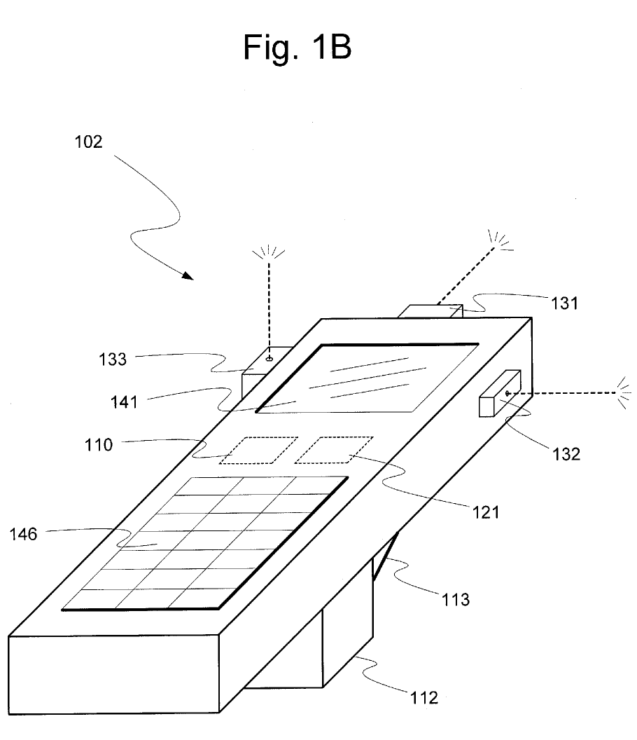

FIG. 1A shows an exemplary system 100 for determining area and/or volume measurements of an operating environment 150 within a handheld MU 101, wherein the operating environment 150 may include plurality of boundaries (e.g., walls, obstacles, etc.) according to the exemplary embodiments of the present invention. According to the exemplary embodiment, FIG. 1A shows a block diagram view of the MU 101 according to the present invention. The MU 101 may be a rugged handheld mobile computing device that may incorporate multiple functionalities from devices such as a mobile telephone, a PDA, a laptop computer, a barcode scanner, and imager, etc. The MU 101 may combine multi-mode wireless networking, voice and data communications, as well as advanced data capturing functions within an exemplary operating environment 150.

The system 100 may include a network, such as a wireless local area network (“WLAN”) deployed within an operating environment 105 for sending and receiving communications from the MU 101. As understood by those skilled in the art, the operating environment 105 may be, for example, an enclosed environment (e.g., a warehouse, a department store, a cargo vessel, an office, a home, etc.) or an open-air environment (e.g., park, campus, etc.) or a combination thereof. The WLAN may include wireless communication devices, such as, one or more access points (“APs”) wirelessly communicating with the MU 101. The APs may be connected to a server or other network device via the WLAN. While the exemplary network may be described as being a wireless network infrastructure, the exemplary embodiments of the present invention may also be implemented into a wired infrastructure having a wireless AP. Furthermore, it should be noted that aside from a WLAN, the exemplary embodiments of the present invention may be implemented within any wireless network architecture, such as, for example, as a mesh network (e.g., an ad-hoc network), a wireless personal area network (“WPAN”) (e.g., Bluetooth, ZigBee), a wireless wide area network (“WWAN”), etc. Thus, the MU 101 may support communication functions within a wide variety of networking architectures.

Accordingly, the MU 101 may include a processor 110, a memory 120, a range finder mechanism 130, a display screen 140, and a keypad 145. The range-finder 130 may be communicatively coupled to a further device such as, for example, a data acquisition component (not shown) of the MU 101. The data acquisition component of the MU 101 may incorporate a variety of auto-ID input methods including, but not limited to, barcode scanning, imaging (i.e., photo capturing), radio frequency identification (“RFID”) tracking, location awareness (i.e., real-time location systems (“RTLS”)), global positioning system (“GPS”) devices, and peer-to-peer communications (i.e., ad-hoc communications), etc. In addition, the MU 101 may also include a leveling component (not shown) in order to indicate if the range finder 130 of the MU 101 is aimed at a level (or plumb) position. The leveling component may include one or more accelerometers, a spirit level (i.e., a bubble level), etc.

It is important to note that the function module may include one or more electrical and/or mechanical components for executing a function of the exemplary MU 101. For example, if the auto-id input component of the MU 101 is an RFID reader, then the processor 110 may include an RF transmitting and receiving arrangement for reading RF tags. The processor 110 may also include software components for controlling operation of the electrical/hardware components.

The processor 110 may regulate the operation of the MU 101 by facilitating communications between the various components of the MU 101. For example, the processor 110 may include a processor, such as a microprocessor, an embedded controller, an application-specific integrated circuit (“ASIC”) chip, a programmable logic array, etc. The processor 110 may perform data processing, execute instructions and direct a flow of data between devices coupled to the processor 110 (e.g., the memory 120, the range finder 130, the display 140, etc.).

As explained below, the processor 110 may receive one or more measurement inputs from the range finger 130 and in response, may calculate a distance, area, and/or volume of a specific region of the operating environment 150. Furthermore, the processor 110 may use the measurement inputs to adjust a known distance, area, and/or volume in order to distinguish occupied space from empty space within the region. For example, the processor 110 may calculate a volumetric measurement of a shipping container to be 500 cubic feet. However, the processor 110 may further calculate that 125 cubic feet of that container is occupied by cargo. Accordingly, the processor 110 may adjust the container space measurement to be 375 square feet of empty space within the container.

The range finder 130 may include any combination of hardware and/or software for monitoring a distance range from the MU 101 to a target, such as one or more boundaries of the operating environment 105. According to one embodiment of the present invention, the ranger finder 130 may implement the use of laser light technology for determining distance measurements. For example, the range finder 130 may include a laser radar system, such as a light detection and ranging (“LIDAR”) system. A LIDAR system may be described as an optical remote sensing technology that measures properties of scattered light in order to find a range to a target. Similar to standard radar technology that uses radio waves, the range to a target may be determined by measuring the time delay between transmission of a pulse and detection of the reflected signal.

Accordingly, the ranger finder 130 may determine time-of-flight measurements of a one-dimensional laser beam. The time-of-flight measurements may be based on the time required for a laser pulse emitted from the range finder 130 to travel to a boundary and reflect back to the range finder 130. Accordingly, since the speed of light is known, an accurate calculation of the distance may be determined from a precise time measurement. Furthermore, the time-of-flight method may allow for several laser pulses to be fired sequentially and the average measurement may be used. Due to the precision required for accurate distance measurements, the range finder 130 may include very accurate sub-nanosecond timing circuitry. Thus, the use of time-of-flight measurements may accurately measure large distances such as hundreds of meters having typical accuracies within a few millimeters or centimeters.

According to another embodiment of the exemplary MU 101 of the present invention, the range finder 130 may include a phase-shift measuring method. According to this method, the range finder 130 may measure the phase shift of multiple frequencies on reflection then solves some simultaneous equations to give a final measurement. Specifically, the laser beam having a sinusoidally modulated optical power may be transmitted to the target (e.g., a boundary within the operating environment 105). The reflected light (e.g., from diffuse and/or specular reflections) may be monitored, and the phase of the power modulation may then be compared with that of the transmitted laser light. By choosing an appropriate modulation frequency, the range finder 130 may adjust the distance sensitivity to the required level in order to calibrate the distance measurements.

According to a further embodiment of the exemplary MU 101 of the present invention, the range finder 130 may use alternative proximity sensing technology, such as spatial parallax range detection or other triangulation techniques. Accordingly, the range finder 130 may include at least two different viewing perspectives of a target, and thus, may be capable of determining distance ranges through the use of spatial parallax range detection. Spatial parallax may be described as a distance between a stereo pair of measurements taken of the same target from the at least two different viewing perspectives of the range finder 130. Spatial parallax may define an apparent shift in the position of the target in a field of view due to the relative change in position of that target and the location from which the target is viewed. Accordingly, the range finder 130 of the exemplary embodiment of the MU 101 may determine a distance range by reading a distance-measuring portion that is offset from center. The offset of the distance-measuring portion may be due to a parallax effect. This offset may be converted into a distance from the MU 101 to the target after any necessary calibrations are made to the range finder 130.

According to the exemplary embodiments of the present invention, the range finder 130 may be in communication with the processor 110 and may transmit the monitored distances to the processor 110. The monitored distances may include measurements between the MU 101 and one or more boundaries of the operating environment 105. Thus, the processor 110 may then process the data to calculate the measurements such as areas and/or volumes of the operating environment 105.

The memory 140 may be any storage medium capable of being read from and/or written to by the processor 110, or another processing device. The memory 140 may include any combination of volatile and/or nonvolatile memory (e.g., RAM, ROM, EPROM, Flash, etc.) The memory 140 may also include one or more storage disks such as a hard drive. Accordingly to one embodiment of the present invention, the memory 140 may be a temporary memory in which data may be temporarily stored until it is transferred to a permanent storage location (e.g., uploaded to a server or a personal computer). In another embodiment, the memory 140 may be a permanent memory comprising an updateable database. For example, the memory 140 may be a running tally of the empty space volume available on a large number of shipping containers for a vessel. The running tally may include individual totals for each container, as well as an overall combined volume of all of the containers. Accordingly, a cargo loader may refer to the memory 140 in order to quickly ascertain the amount of available storage space in each container and within the vessel itself.

FIG. 1B shows an alternative embodiment of the MU 102 for determining area and/or volume measurements of the operating environment 150 according to the exemplary embodiments of the present invention. Similar to the MU 101 of FIG. 1A, the MU 102 may include a processor 110, a memory 121, a display screen 141, and a keypad 146. According to the alternative embodiment, the MU 102 may include multiple range finder components 131-133. Furthermore, the MU 102 may also include a handle 112 and trigger 113. The trigger 113 may be used to activate specific functions of the MU 102, such as activating the range finders 131-133 in order to determine distances to one or more boundaries of the operating environment 150.

Each of the range finders 131-133 may be aimed towards a different dimension. For example, the range finder 131 may be aimed at a depth dimension, measuring a distance from the MU 102 to a target along the z-axis. The range finder 132 may be aimed at a width dimension, measuring a distance from the MU 102 to a target along the x-axis. The range finder 133 may be aimed at a height dimension, measuring a distance from the MU 102 to a target along the y-axis. Accordingly, the arrangement of the range finders 131-133 may allow the MU 102 may simultaneously measure distances in three dimensions.

It should be noted that while the exemplary MU 102 is illustrated and described as having three range finders 131-133, any number of range finders may be implement on the MU 102. For example, the MU 102 may simply include two range finders to measure in two dimensions, wherein the third dimension measurement is either unneeded or a known value. In another example, the MU 102 may include a second range finder for each dimension. For example, the MU 102 included ranger finder 132 aimed up along the height dimension and a further range finder (opposite to range finder 132) aimed down along the height dimension. Thus, as opposed to placing the MU 102 on one of the boundaries to calculate the height, a combined height measurement may be taken from these two range finders while the MU 102 is held between two boundaries in the height dimension. Likewise, each dimension may include two range finders aimed at opposite direction, wherein the respective height, width, and depth measurements may be calculated from the combined readings of the range finders.

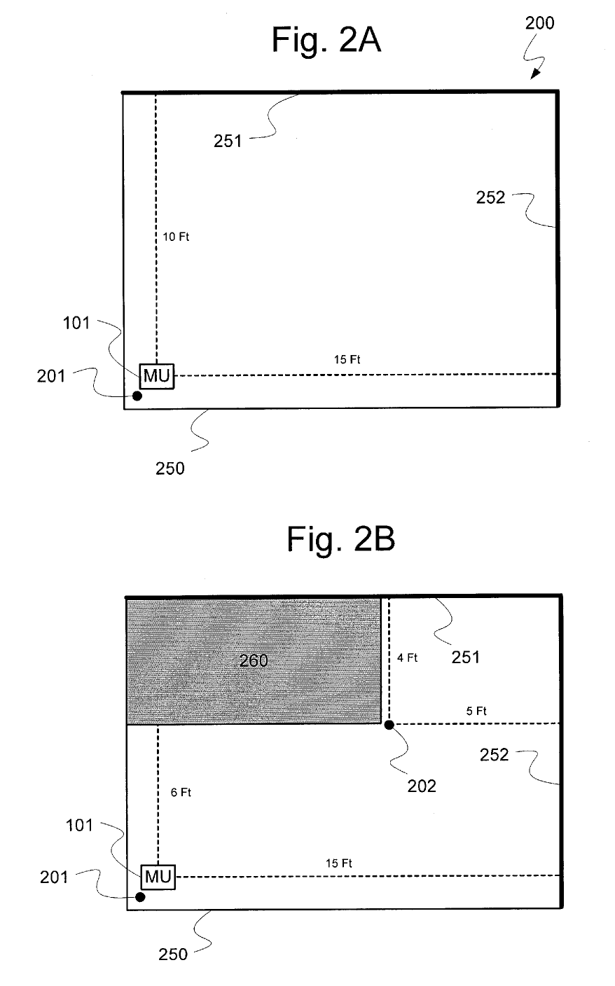

FIG. 2A shows an exemplary system 200 for determining an overall area measurement of an operating environment 250 with the MU 101 according to the exemplary embodiments of the present invention. The exemplary operating environment 250 may include a depth boundary 251 and a width boundary 252. The exemplary system 200 will be described with reference to the exemplary system 100 of FIG. 1A. Initially, the MU 101 may be placed in the position 201, at the corner of the operating environment 250. The MU 101 may use the range finder 130 to determine a distance from the MU 101 to the depth boundary 251. For example, the MU 101 may determine that the depth of the operating environment is 10 feet. The MU 101 then may use the range finder 130 to determine a distance from the MU 101 to the width boundary 252. For example, the MU 101 may determine that the width of the operating environment is 15 feet. These distance measurements may be transmitted to the processor 110, wherein the processor 110 calculates the overall area measurement of the operating environment 250. According to the exemplary measurements, the processor 110 would calculate the area to be 150 square feet (10 ft×15 ft). It should be noted that the MU 101 may be calibrated to adjust for the distance of the MU 101, itself. In other words, the dimensions of the MU 101 may be added to the overall distance measurement in order to provide a more accurate measurement.

FIG. 2B shows the exemplary system 200 for determining an overall area measurement of operating environment 250 with the MU 101 wherein the operating environment 250 includes an obstacle 260 (e.g., space within a container occupied by cargo) according to the exemplary embodiments of the present invention. The obstacle may include a depth boundary 261 and a width boundary 262. Similar to FIG. 2A, the MU 101 may be placed in a first position 201, at the corner of the operating environment 250. The MU 101 may use the range finder 130 to determine a distance from the MU 101 to the obstacle depth boundary 261. For example, the MU 101 may determine that the depth from position 201 to the obstacle is 6 feet. The MU 101 then may use the range finder 130 to determine a distance from the MU 101 to the width boundary 252. For example, the MU 101 may determine that the width of the operating environment is still 15 feet. These distance measurements may be transmitted to the processor 110, wherein the processor 110 calculates a first empty area measurement within the operating environment 250. According to the exemplary measurements, the processor 110 would calculate the first empty area to be 90 square feet (6 ft×15 ft).

Next, the MU 101 may then be placed in a second position 202, at the corner of the obstacle 260. The MU 101 may use the range finder 130 to determine a distance from the MU 101 at the new position 202 to the depth boundary 251. For example, the MU 101 may determine that the depth from position 202 to the depth boundary 251 is 4 feet. The MU 101 then may use the range finder 130 to determine a distance from the MU 101 at the position 202 to the width boundary 252. For example, the MU 101 may determine that the width of the operating environment is 5 feet. These distance measurements may be transmitted to the processor 110, wherein the processor 110 calculates a second empty area measurement within the operating environment 250. According to the exemplary measurements, the processor 110 would calculate the second empty area to be 20 square feet (4 ft×5 ft). Finally, the processor 110 may combine the first and second area of empty space to calculate the overall empty space within the operating environment 250. According to the exemplary measurements, the overall empty space of the operating environment 250 would be calculated to be 110 square feet (90 ft²+20 ft²), wherein the obstacle 260 may be presumed to occupy 40 square feet (150 ft²−90 ft²).

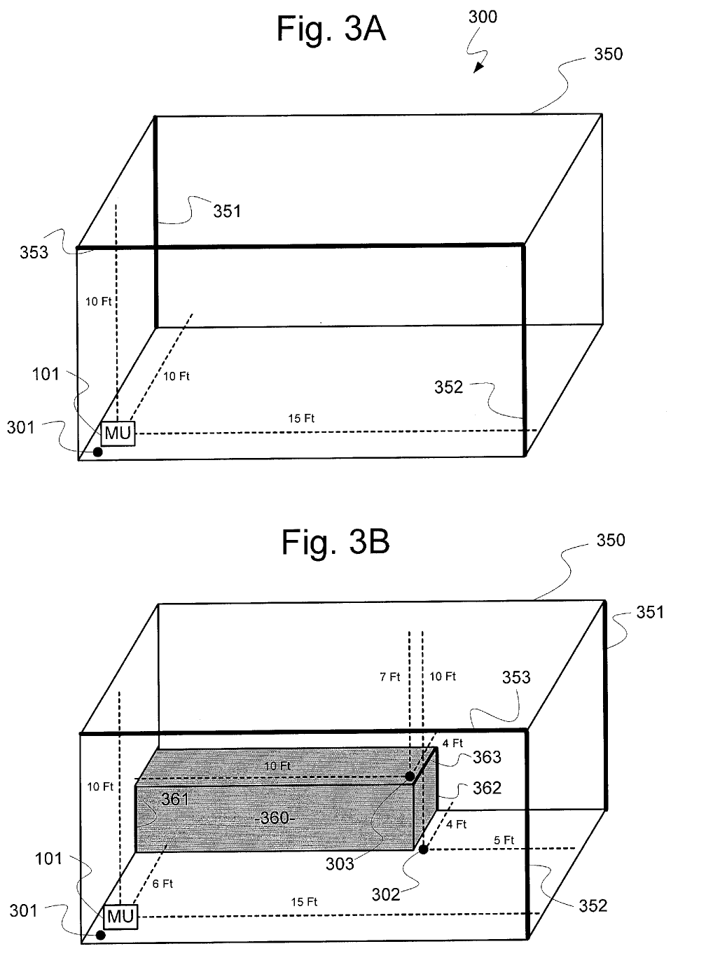

FIG. 3A shows an exemplary system 300 for determining an overall volume measurement of an operating environment 350 with the MU 101 according to the exemplary embodiments of the present invention. The exemplary operating environment 350 may include a depth boundary 351, a width boundary 352, and a height boundary 353. Initially, the MU 101 may be placed in a first position 301, at the corner of the operating environment 350. The MU 101 may use the range finder 130 to determine a distance from the MU 101 to each of the boundaries 351-353. For example, the MU 101 may determine that the depth to be 10 feet, the width to be 15 feet, and the height to be 10 feet. These distance measurements may be transmitted to the processor 110, wherein the processor 110 calculates the overall volume measurement of the operating environment 350. According to the exemplary measurements, the processor 110 would calculate the volume to be 1500 cubic feet (10 ft×15 ft×10 ft).

FIG. 3B shows the exemplary system 300 for determining an overall volume measurement of operating environment 350 with the MU 101 wherein the operating environment 350 includes an obstacle 360 (e.g., space within a container occupied by cargo) according to the exemplary embodiments of the present invention. The obstacle may include a depth boundary 361, a width boundary 362, and height boundary 363. Similar to FIG. 3A, the MU 101 may be placed in the position 301, at the corner of the operating environment 350. The MU 101 may use the range finder 130 to determine a distance from the MU 101 to the obstacle depth boundary 361, the width boundary 352, and the height boundary 353. For example, the MU 101 may determine that the depth from position 301 to the obstacle is 6 feet and the width and height of the operating environment is still 15 feet and 10 feet, respectively. These distance measurements may be transmitted to the processor 110, wherein the processor 110 calculates a first empty volume measurement within the operating environment 350. According to the exemplary measurements, the processor 110 may calculate the first empty volume to be 900 square feet (6 ft×15 ft×10 ft).

Next, the MU 101 may then be placed in a second position 302, at one corner of the obstacle 360, aligned with the width boundary 362 of the obstacle 360. The MU 101 may use the range finder 130 to determine a distance from the MU 101 at the new position 302 to the depth boundary 351, width boundary 352, and height boundary 353. For example, the MU 101 may determine that the depth from position 302 to the depth boundary 351 is 4 feet, and the width and the height of the operating environment 350 from point 302 is 5 feet and 10 feet, respectively. These distance measurements may be transmitted to the processor 110, wherein the processor 110 calculates a second empty volume measurement within the operating environment 350. According to the exemplary measurements, the processor 110 may calculate the second empty volume to be 200 cubic feet (4 ft×5 ft×10 ft).

Next, the MU 101 may then be placed in a third position 303, at another corner of the obstacle 360, aligned with the height boundary 363 of the obstacle 360. The MU 101 may use the range finder 130 to determine a distance from the MU 101 at the new position 303 to the depth boundary 351, a further width boundary (opposite of width boundary 352), and the height boundary 353. For example, the MU 101 may determine that the depth, width, and height from position 303 are 4 feet, 10 feet, and 7 feet, respectively. These distance measurements may be transmitted to the processor 110, wherein the processor 110 calculates a third empty volume measurement within the operating environment 350. According to the exemplary measurements, the processor 110 may calculate the third empty volume to be 280 cubic feet (4 ft×10 ft×7 ft).

Finally, the processor 110 may combine the first, second, and third volumes of empty space to calculate the overall empty space within the operating environment 350. According to the exemplary measurements, the overall empty space of the operating environment 350 would be calculated to be 1380 cubic feet (900 ft³+200 ft³+280 ft³), wherein the obstacle 360 may be presumed to occupy 120 cubic feet (1500 ft³−1380 ft³). It should also be noted that the volume of the obstacle 360 may be calculated by the processor 110 through an alternative method of subtracting measured distances in each of the dimension. Specifically, the width of the obstacle 360 may be calculated by subtract the width measurement at position 302 (5 ft) from the width measurement at position 301 (15 ft) in order to calculate the width of the obstacle 360 to be 10 ft. The height of the obstacle 360 may be calculated by subtract the height measurement at position 303 (7 ft) from the height measurement at position 303 (10 ft) in order to calculate the height of the obstacle 360 to be 3 ft. The depth of the obstacle can be measured at position 302 to be 4 ft. Thus, the volume of the obstacle can also be computed via this alternative method to also be 120 cubic feet (10 ft×3 ft×4 ft).

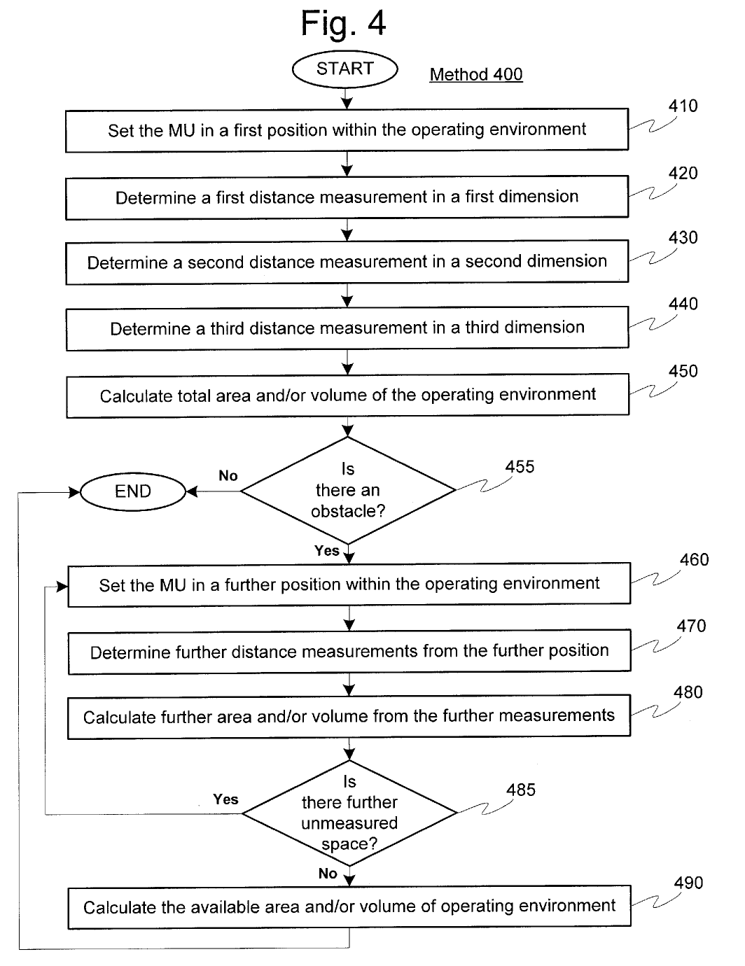

FIG. 4 shows an exemplary method 400 for measuring distances using a laser distance meter of a hand-operated device, such as MU 101, according to the exemplary embodiments of the present invention. The exemplary method 400 will be described with reference to the exemplary system 100 of FIG. 1A and system 300 of FIG. 3A. As described above, the exemplary MU 101 may include one or more range finder components 130, wherein the range finder mechanism may calculate distances from the MU 101 to various targets, such as boundaries of the operating environment 350 and/or boundaries of an obstacle within the operating environment 350.

In step 410, the MU 101 may be set in a first position 301 within the operating environment 350. As described above, the operating environment 350 may be a shipping container and the first position may be the corner of the container. Furthermore, the operating environment 350 (e.g., container, etc.) may include at least a first boundary (e.g., a depth boundary), a second boundary (e.g., a width boundary), and a third boundary (e.g., a height boundary). In addition, the operating environment 350 may include an obstacle 360 (e.g., cargo, occupied space, etc.) having its own depth, width, and height boundaries, 361, 362, 363, respectively.

In step 420, the MU 101 may determine a first distance measurement in a first dimension, such as the depth dimension, between the first position 301 and a depth boundary (e.g., the environment depth boundary 351, obstacle depth boundary 361, etc.). As described above, the MU 101 may include at least one range finder components 130. Accordingly, the range finder 130 may utilize any number of methods (e.g., laser time-of-flight methods) to determine an accurate distance reading of the depth measurement of the operating environment 350.

In step 430, the MU 101 may determine a second distance measurement in a second dimension, such as the width dimension, between the first position 301 and a width boundary (e.g., the environment width boundary 352, obstacle width boundary 362, etc.). It should be noted that any known dimensions of either the operating environment 350 or the obstacle 360 may be manually entered into the MU 101 via the keypad 145. For example, it may be known that the shipping container has a height of 10 ft. Accordingly, the MU 101 may not need to may a distance measurement in the height dimension.

In step 440, the MU 101 may determine a third distance measurement in a third dimension, such as the height dimension, between the first position 301 and a height boundary (e.g., the environment height boundary 353, obstacle depth height 363, etc.). As described above, the step 440, or any of the measuring steps 420-440, may be eliminated by allowing a user of the MU 101 to manually input one of the dimension measurements via the keypad 145. Once each of the depth, width, and height distance measurements have been made, the measurements may be stored in the memory 140 and/or transmitted to the processor 110 for calculations.

In step 450, the processor 110 of the MU 101 may calculate either an total area (e.g., depth by width) of the operating environment 350 or may calculate an total volume (e.g., depth by width by height) of the operating environment 350 based on the distance measurements. As described above, the calculations of the overall area or volume may depend on whether or not a portion of the operating environment 350 is occupied (e.g., by the obstacle 360, or the like). Thus, in step 455, a determination may be made as to if there is an obstacle 360. If there is not an obstacle 360, the operating environment is empty and the total area/volume calculated in step 450 may be consider the overall area/volume. If there is an obstacle 360, the method 400 may advance to step 460.

In step 460, the MU 101 may be set in a further position (e.g., position 302 or position 303) within the operating environment 350. As described above, the further position may be a corner of the obstacle 360 within the operating environment 350. Thus, the further position may allow the MU 101 to determine a further area/volume measurement of unoccupied space within the operating environment 350.

In step 470, the MU 101 may determine further distance measurements from the further position. For example, if the objective of the MU 101 is to determine the overall empty area in the operating environment, the MU 101 may determine further depth and width measurements. If the objective of the MU 101 is to determine the overall empty volume of the operating environment, the MU 101 may also determine a further height measurement. According to alternative embodiment, the MU 101 may be used to determine an area/volume measurement of the space occupied by the obstacle 360. In other words, the further position may be selected to allow the MU 101 to measure, or closely estimated, the area/volume of the obstacle 360 itself. This measurement may then be used to adjust the overall area/volume of the operating environment 350 accordingly.

In step 480, the processor 110 may calculate a further area/volume measurement based on the further distance measurements. Furthermore, in step 485, it may be determined if another area/volume measurement of the operating environment 350 needs to be measured (e.g., if there is further unmeasured empty space). In other words, if another region of unoccupied space exists that has not been measured by the MU 101, the method 400 may return to step 460 wherein the MU 101 is repositioned to a further position and a further area/volume measurement of empty space is determined by the range finder(s) 130. If there are no further regions of unmeasured empty space, the method may advance to step 490.

Finally, in step 490, the processor 110 may calculate an available area/volume of empty space (e.g., a location area/volume) based on the sum of the total area/volume measurements and each of the further second area/volume measurements. Alternatively, the available area/volume of free space may be calculated based on the difference of any area/volume determined to be occupied from the total area/volume measurement.

While the exemplary embodiments of the present invention describe various methods and manners of measuring and distances and performing calculations based on the measured distances, those of skill in the art will understand that the principles and functionalities described herein may be performed in a software program, a component within a software program, a hardware component, or any combination thereof. One example would be a set of instructions stored on a computer readable storage medium (e.g. memory) executable by a processor, where the set of instructions may perform the various methods and manners according to exemplary embodiments of the present invention.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A device, comprising:
a range finder measuring a distance; and
a processor receiving the distance from the range finder and performing a calculation based on the distance.

2. The device of claim 1, wherein the calculation determines one of an area and a volume.

3. The device of claim 1, wherein the distance includes a first distance from a first position to a first boundary in a first direction and a second distance from the first position to a second boundary in a second dimension, the calculation determining a first area based on the first and second distances.

4. The device of claim 3, wherein the distance includes a third distance from the first position to a third boundary in a third dimension, the calculation determining a first volume based on the first, second and third distances.

5. The device of claim 3, wherein the distance includes a further first distance from a second position to a further first boundary in the first dimension, and a further second distance from the second position to a further second boundary in the second dimension, the calculation determining a second area based on the further first and the further second distances and a total area based on one of the sum of the first area and the second area and the difference of the first area and the second area.

6. The device of claim 4, wherein the distance includes a further first distance from a second position to a further first boundary in the first dimension, and a further second distance from the second position to a further second boundary in the second dimension, and a further third distance between the second position and a further third boundary in the third dimension, the calculation determining a second volume based on the further first distance, further second distance, and further third distance, and a total volume based on one of the sum of the first volume and the second volume and the difference of the first volume and the second volume.

7. The device of claim 1, wherein the range finder includes a first and second measuring components, the first measuring component being aimed in a first dimension and the second measuring component being aimed in a second dimension.

8. The device of claim 7, wherein the range finder includes a further measuring component aimed in a third dimension.

9. The device of claim 1, wherein the range finder measures the distance via one of a triangulation method, a laser time-of-flight method, a laser pointer pulse method, and a laser phase-shift method.

10. The device of claim 1, wherein the device further comprises a transceiver for wireless communication.

11. The device of claim 1, wherein the device is one of a personal digital assistant (“PDA”), an enterprise digital assistant (“EDA”), a digital wireless telephone, a two-way radio, a barcode scanner, an image-based scanner, a laser-based scanner, a radio-frequency identification (“RFID”) reader, and a handheld global positioning system (“GPS”).

12. The device of claim 1, further comprising:
a display displaying a result of the calculations to a user.

13. A method, comprising:
determining, using a range finder included in a mobile device, a distance; and
calculating, using a processor of the mobile device, one of an area and a volume based on the distance.

14. The method of claim 13, further comprising:
determining a first distance from a first position to a first boundary in a first dimension;
determining a second distance from the first position to a second boundary in a second dimension; and
calculating a total area based on the first and second distances.

15. The method of claim 14, further comprising:
determining a third distance from the first position to a third boundary in a third dimension; and
calculating a total volume based on the total area and the third distance.

16. The method of claim 14, further comprising:
determining a further first distance from a second position to a further first boundary in the first dimension;
determining a further second distance from the second position to a further second boundary in the second dimension;
calculating a second area based on the further first and the further second distances; and
calculating a location area based on one of the sum of the total area and the second area and the difference of the total area and the second area.

17. The method of claim 15, further comprising:
determining a further first distance from a second position to a further first boundary in the first dimension;
determining a further second distance from the second position to a further second boundary the in the second dimension;
determining a further third distance from the second position to a further third boundary in a third dimension;
calculating a second volume based on the further first distance, the further second distance and the further third distance; and
calculating a location volume based on one of the sum of the total volume and the second volume and the difference of the total volume and the second volume.

18. The method of claim 13, wherein the range finder determines the distance via one of a triangulation method, a laser time-of-flight method, a laser pointer pulse method, and a laser phase-shift method.

19. The method of claim 13, wherein the mobile device is one of a personal digital assistant (“PDA”), an enterprise digital assistant (“EDA”), a digital wireless telephone, a two-way radio, a barcode scanner, an image-based scanner, a laser-based scanner, a radio-frequency identification (“RFID”) reader, and a handheld global positioning system (“GPS”).

20. An arrangement, comprising:
a distance determining means for determining a distance; and
a calculating means for calculating one of an area and a volume based on the distance.
